(19) United States
(12) Patent Application Publication
(10) Pub. No.: US 2009/0217315 A1
(43) Pub. Date: Aug. 27, 2009

(54) METHOD AND SYSTEM FOR AUDIENCE MEASUREMENT AND TARGETING MEDIA

(75) Inventors: Shahzad Alam Malik, Ottawa (CA); Haroon Fayyaz Mirza, Mississauga (CA)

Correspondence Address: MILLER THOMPSON, LLP, Scotia Plaza, 40 King Street West, Suite 5800, TORONTO, ON, M5H 3S1, CA

(73) Assignee: COGNOVISION SOLUTIONS INC., Mississauga (CA)

(21) Appl. No.: 12/037,792

(22) Filed: Feb. 26, 2008

(51) Int. Cl. H04H 60/33; H04N 7/18

(52) U.S. Cl. 725/9; 348/77; 348/E07.085

(57) ABSTRACT

An audience measurement and targeted media system and method provides media targeted to the attributes of a particular audience. The method and system may be undertaken as an anonymous process for detecting the presence of individuals in the vicinity of a display and detecting whether said individuals are viewing the display. For this purpose one or more cameras positioned and operable to establish audience attributes and detect audience movement. Attributes of the individuals may also be measured and utilized to rank media based on the attributes of individuals viewing the media on the display. The method and system can allow for media corresponding to the attributes of the audience to be displayed in real-time or near real-time, so as to cause media targeted to said audience to be displayed on the display. The method and system may further generate reports regarding the effectiveness of the display.

### FIELD OF INVENTION

This invention relates in general to the field of media displays to an audience. In particular it relates to a method and system for measuring audience attributes and for providing targeted media based upon said attribute measurements.

### BACKGROUND OF THE INVENTION

The use of digital display devices in both indoor and outdoor environments is growing at a significant rate. Digital display devices may be located almost anywhere as they are now suited to placement in an assortment of indoor and outdoor sites, and may be of various sizes. As a result, advertisers are increasingly relying upon digital display devices to deliver their message.

However, unlike other forms of media, it is difficult to measure the effectiveness of a particular digital display device. In particular, it can be challenging to determine the number of potential or actual viewers. Yet, in order to effectively advertise, information regarding the size, attributes and demographics of any audience that is in the vicinity of a display device and/or is viewing a display device is required. One approach to measuring this information is to manually compile data based on human observations of the audience. However, such an approach can be time-consuming and costly. Additionally, manual observations cannot easily be applied to determine the most appropriate advertisement to display based on the audience attributes, particularly if the set of advertisements available for display is very large.

Prior art responses have tried to address some of the difficulties of detecting people within a crowd. For example, a single overhead camera has been applied by prior art, such as US Patent Application No. 2006/0269103 and US Patent Application No. 2007/0127774, but these methods merely detect the whereabouts of people, or supply a head count. Moreover, such detection systems utilize simplistic means to determine the representation of a person upon a video feed, including mergers and splits of a region of interest, or the identification of blobs and the assumption that each blob represents a single person. Furthermore, such methods recognize movement, rather than the attributes of individuals. For these reasons, these methods of identifying persons within a video feed may be inaccurate.

A further problem associated with overhead camera systems, such as those in the patents identified above, is that they tend to involve a single overhead camera that is not positioned and operable to establish audience attributes. Although benefits may be gained through the use of an overhead view supplied by the overhead camera systems the information collected can be less accurate than a system involving both an overhead camera and a front facing camera, for the purpose of gathering audience attributes.

Additionally, the exclusive use of a front-facing camera to review audience attributes, as applied in US Patent Application No. 2005/0198661 may also be limited, particularly as the camera is not positioned or operable to establish audience attributes and detect audience movement. Furthermore, the use of multiple cameras or sensors that are not positioned to capture both overhead and front views of a specific region of interest, as the aforementioned patent application discloses as does US Patent Application No. 2007/0271580, will provide less accurate information for the purpose of gathering audience attribute information than other more directed methods.

Prior art approaches to the gathering of audience information may also look to traffic or heat map information to collect data. This approach requires trajectory information, such as is exemplified by the method of US Patent Application No. 2007/0127774. The processing of individual trajectories can be inefficient to generate.

What is required to collect accurate audience data, indicating the response of an audience to displayed media, is a system and method having an overhead camera and a front facing camera, as well as the ability to evaluate the attributes of the audience from collected visual feeds. Alternatively a single camera may be utilized, being positioned and operable to establish audience attributes and detect audience movement. Moreover, the implementation of targeted methods of improving accuracy, such as two-pass face detection can decrease false positives and improve accuracy. Efficiency improvement facilities, such as the use of difference images to define localized search regions, can also provide a significant forward step in the art of audience attribute collection for the purpose of targeting media to an audience. Furthermore, there is a need in the art for a system and method for detection in an anonymous manner, meaning that no information applicable to identifying a specific person may ever be retrieved based on the detection process. Present face recognition algorithms are able to identify unique attributes between two or more faces, to a level of granularity where the data collected can be used to personally identify an individual.

### SUMMARY OF THE INVENTION

In one aspect of the invention, an audience measurement and targeted media system comprising: a display for the presentation of content or media; one or more cameras positioned and operable to capture images of targets in an area in the proximity of the display; and an audience analysis utility that analyzes the images or portions thereof captured by the one or more cameras by processing the images or image portions so as to establish correlations between two or more images or image portions, so as to detect audience movement in the area and establish one or more audience attributes.

In another aspect of the invention, a method of targeting media based on an audience measurement comprising the steps of: capturing images by way of one or more cameras of an audience within an audience area in proximity to a display; processing the images to identify individuals within the audience; analyzing the individuals to establish attributes; corresponding the established attributes to a media presented on the display at the time of the capture of the image; and tailoring media presented on a display to the attributes of an audience in the audience area.

In yet another aspect of the invention, an audience measurement and targeted media system comprising: a display for the presentation of content or media; two or more cameras for capturing images of an audience area in the proximity of the display including; a first camera positioned overhead of the audience area; a second camera positioned facing outward from the display. A computer having data processor capabilities including; a processor for deriving information from the images of said one or more cameras; a processor for establishing attributes of individuals viewing the content or media of the display using the derived information; and a processor for controlling the display.

In another aspect of the invention, a method of targeting media based on an audience measurement comprising the steps of: positioning in proximity to a display a first camera overhead of an audience area; positioning a second camera forward facing outwardly from the display to capture images of an audience area; capturing images by way the first and second cameras; processing the images to identify individuals within the audience; analyzing the individuals to establish audience attributes; corresponding the established audience attributes to media presented on the display at the time of the capture of the image; and tailoring media presented on a display to the attributes of an audience in the audience area in real-time.

### BRIEF DESCRIPTION OF THE DRAWINGS

FIG. 1 is a block diagram of the display device and audience monitoring elements of the system.

FIG. 2 is a block diagram of the elements of the Audience Analysis Suite.

FIG. 3 is a front view of the display device and mounted cameras.

FIG. 4 is a block diagram of the elements of the Visitor Detection Module.

FIG. 5 is a block diagram of the elements of the Viewer Detection Module.

FIG. 6 is a block diagram of the elements of the Content Delivery Module.

FIG. 7 is a block diagram of the elements of the Business Intelligence Tool.

FIG. 8 is a flow chart illustrating the visitor detection method.

FIG. 9 is a flow chart illustrating the viewer detection method.

FIG. 10 is a flow chart illustrating the content delivery method in playlist mode.

FIG. 11 is a flow chart illustrating the targeted media delivery method.

In the drawings, one embodiment of the invention is illustrated by way of example. It is to be expressly understood that the description and drawings are only for the purpose of illustration and as an aid to understanding, and are not intended as a definition of the limits of the invention.

### DETAILED DESCRIPTION OF THE INVENTION

The present invention relates to a method and system for collecting data relevant to the response of an audience to displayed media. The present invention may apply multiple cameras, with at least one able to detect the movement of individuals in close proximity to a display, and at least one other positioned to capture images showing views of the faces of audience members in close proximity to the display whereby reactions to the display may be evaluated. Alternatively, a single camera may be utilized to capture audience attributes. Depending upon the audience area the targets being captured in the camera images, a single camera may be positioned and operable to capture one or more images permitting detection of movement of the targets in the area; and one or more images permitting establishment of attributes for the targets.

In particular the present invention may evaluate whether audience members are facing the display, and the amount of time that audience members remain facing a display. Further attributes, for example those that are behavioural and demographic, may also be evaluated by the present invention.

The audience analysis data may be aligned with the media on display. For example, if females in an audience were more attentive to particular media, and children to others, or people over the age of 50 responded to other media, these audience attributes can be recorded as associated with the specific media. The result is that audience analysis data may be utilized to tailor a media display to a particular audience. Alternatively, audience analysis data may be utilized or for other audience and media correlation purposes, such as marketing of a display.

Audience analysis data may be stored in a storage medium, such as a database, which may be an external or internal database. Alternatively, analysis data may be transferred to another site immediately upon its creation and may be processed at that site.

Additionally, the present invention may function in real-time or near real-time. Factors, such as utilizing cameras that capture low-granularity images to derive audience data can increase the speed of the present invention. The result is that audience data may be produced in real-time or near real-time. Real-time function of the present invention may be advantageous particularly if the display is a digital display whereby the content displayed thereon may be tailored to the audience standing before the display.

Another feature of utilizing cameras in the present invention that are set to capture lower granularity images is that the audience members remain virtually anonymous. This may prevent the present invention from infringing privacy laws.

The embodiments described in this document exemplify a method and system for providing business intelligence on the effectiveness of a display and for delivering targeted media to a display. The term “media” is intended to encompass all types of presentation, that of artwork, audio, video, billboard, advertisement, and any other form of presentation or dispersion of information.

In embodiments of the present invention, the elements may include a digital display, an audience of one or more people, one or more cameras for the collection of data relating to the audience in front of the digital display, and a computer means for processing such data and causing the digital display to provide media targeted to the audience.

The embodiments of elements of the system and method of the present invention may be implemented in hardware or software, or a combination of both. However, preferably, these embodiments are implemented in computer programs executing on programmable computers each comprising at least one processor, a data storage system (including volatile and non-volatile memory and/or storage elements), at least one input device, and at least one output device. For example and without limitation, the programmable computers may be a mainframe computer, server, personal computer, embedded computer, laptop, personal data assistant, or cellular telephone. Program code may be applied to input data to perform the functions described herein and generate output information. The output information may be applied to one or more output devices.

In one embodiment of the invention, each program is implemented in a high level procedural or object-oriented programming and/or scripting language to communicate with a computer system. However, in other embodiments the programs can be implemented in assembly or machine language, if desired. A skilled reader will recognize that the language applied in the present invention may be a compiled, interpreted or other language form.

Computer programs of the present invention may be stored on a storage media or a device, such as a ROM or magnetic diskette, however any storage media or device that is readable by a general or special purpose programmable computer, for configuring and operating the computer when the storage media or device is read by the computer to perform the procedures described herein, may be utilized. In another embodiment of the present invention, a computer-readable storage medium, configured with a computer program, where the storage medium so configured causes a computer to operate in a specific and predefined manner to perform the functions described herein may be applied.

Furthermore, the method and system of the embodiments of the present invention are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

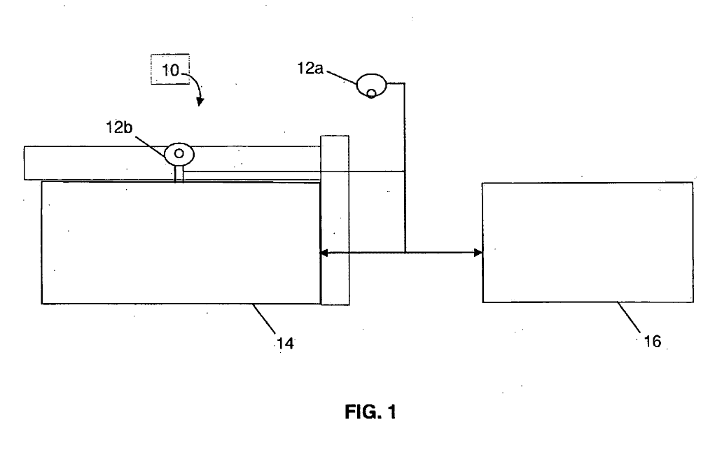

As shown in FIG. 1, in one embodiment of the present invention, the components of an audience measurement and targeted media system 10 may be used to determine and measure the attributes associated with individuals situated in front of one or more displays. The system may include a visitor detection module, a viewer/impression measurement module, and a content delivery module. The term “impression” is used to describe when an individual is facing in the general direction of the display. Once the attributes of the individuals have been determined, media targeted at said individuals may be displayed upon the display.

The term “display” refers to a visual element. For example, a digital display device is a display that is an electronic display, where the images or content that are displayed may change, such as digital signs, digital billboards, and other digital displays. Other displays may include television monitors, computer screens, billboards, posters, mannequins, statues, kiosks, artwork, store window displays, product displays, or any other similar visual media. The term “display” is intended to reference a source of visual media for the presentation of a particular visual representation or information to an audience.

For some embodiments of the present invention, the terms “media” and “content” may be interchangeable, depending on the type of display. For example, if the display is a digital device then the content may be information, advertisements, news items, warnings or video clips presented thereon, while the media may be the digital device. Whereas, if the display is artwork the content and the media may be the same, both being the artwork. The visual element of a display, and therefore its content or media, may also include visual elements of a billboard, the visually apparent aspects of a statue or mannequin, or any other such visually recognized information, where such information may involve audio, video, still images, still artwork, any combination thereof, or any other visual media. For this reason, the terms media and content may be read as describing the same element for some embodiments of the present invention and as separate entities in other embodiments depending on the type of display utilized.

In embodiments of the present invention, a display may be located either indoors or outdoors.

In one embodiment of the present invention, as shown in FIG. 1, the measurement system 10 may be comprised of an overhead camera 12a, a front-facing camera 12b, a display 14, and an audience analysis suite 16 which alternatively may be a utility. The overhead camera 12a may be positioned above the area in front of the display, pointing downwards, to detect potential viewers that are in the vicinity of the display 14, also referenced as an audience area. The front-facing camera 12b may be positioned above or below the display 14 and may face in the same direction as the display surface to capture images of any individuals who look towards the respective display.

In one embodiment of the present invention, the operation of the system 10 involves a digital display 14, where the content shown on the display may be changed. Based on the images that are captured by the cameras 12a and 12b, various attributes associated with the individuals who are in the vicinity of and viewing the digital displays 14 may be determined. Such attributes may include the number of people passing the display, the number of viewers, and the behaviour and demographics of the individuals who are looking towards the display. In alternative embodiments of the present invention, other attributes may be included, such as the colour of clothing items, hair colour, the height of each person, brand logos, and other such features which could be detected on individuals. As a person skilled in the art will recognize, additional cameras to those described in this embodiment, as well as different camera positions than those described in the embodiment, may also be applied in the present invention.

In yet another embodiment, the system 10 may be used to detect and measure attributes associated with various types of objects that may pass in the vicinity of the cameras and display, such as automobiles, baby carriages, wheelchairs, briefcases, purses, and other objects or modes of transportation.

Generally, embodiments of the present invention may detect individuals who are members of an audience. The term audience is used to refer to the group of one or more individuals who are in the vicinity of a display at any moment in time. Embodiments of the present invention may collect data regarding the attributes and behaviour of the individuals in the audience.

In one embodiment of the present invention, the system 10 determines the number of individuals that are viewing a display and the number of individuals that are in the vicinity of the display and who may or may not be viewing the display. Based on the attributes associated with the audience, customized digital content may be displayed upon the respective digital displays 14.

In an embodiment of the invention audience attributes may be determined by processing of the images captured by the cameras 12a and 12b that are transmitted to the audience analysis suite 16. The images may be transmitted by wired, wireless methods, or other communication networks. A communication network may be any network that allows for communication between a server and a transmitting device and may include: a wide area network; a local area network; the Internet; an Intranet, or any other similar communication-capable network. The audience analysis suite 16 may analyze the images to determine the audience size recorded in the images, as well as certain attributes of the individuals within the audience.

In one embodiment of the present invention, the audience analysis suite 16 may be a set of software modules or utilities that analyze images captured by the cameras 12a and 12b. Based on the analysis of the respective images captured by the cameras 12a and 12b, various attributes may be determined regarding the individuals who view and/or pass by the display 14. The attributes that are determined may be used to customize the media that is displayed upon-the display 14.

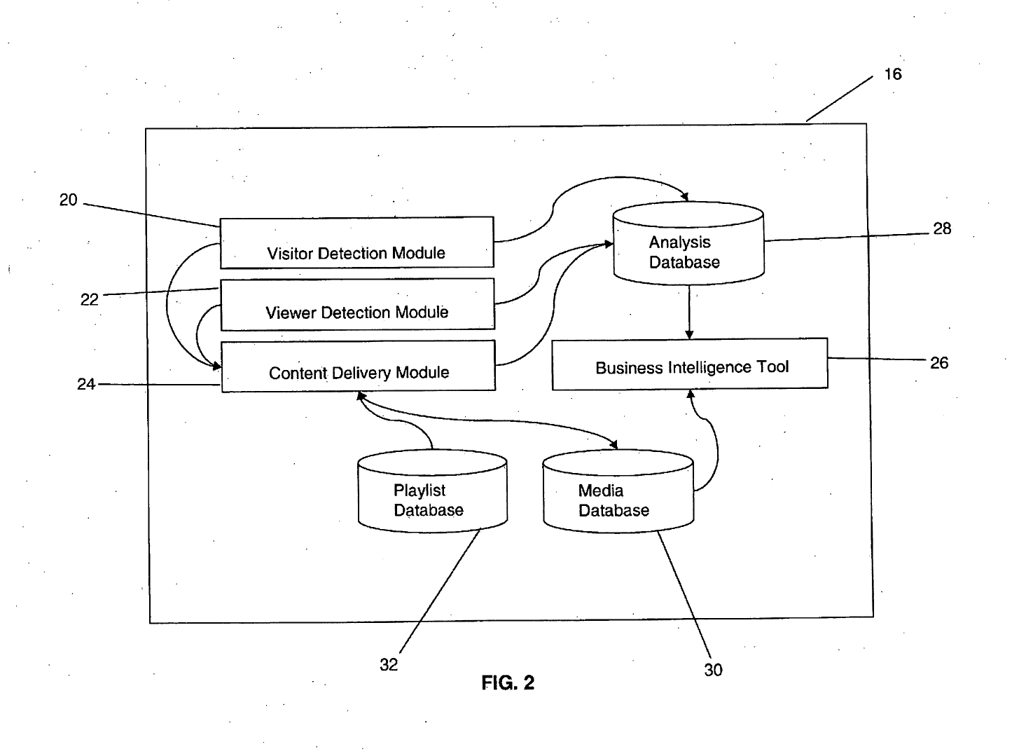

As shown in FIG. 2, one embodiment of the present invention may include an audience analysis suite 16 that is an abstract representation of a set of software modules, or utilities, and storage mediums, such as databases, that can be distributed onto one or more servers. These servers may be located on-site at the same location as the display, or off-site at some remote location. The suite may comprise a visitor detection module 20 or utility, a viewer detection module 22 or utility, a content delivery module 24 or utility, and a business intelligence tool 26. The audience analysis suite may be a utility, as may any of the elements thereof, as described.

The audience analysis suite 16 may also have access to an analysis database 28, a media database 30, and a playlist database 32. The analysis database 28 stores results of analyses performed on the respective images, including information such as the dates and times when an individual is within the vicinity of a display, or when an individual views a display. The media database 30 may store the respective media that can be displayed, and the playlist database 32 may store the playlists used for display, made up of one or more media. The content delivery module 24 may optionally be a third-party software or hardware application, with remote procedure calls being used for communication between it and the other three modules and databases of the present invention.

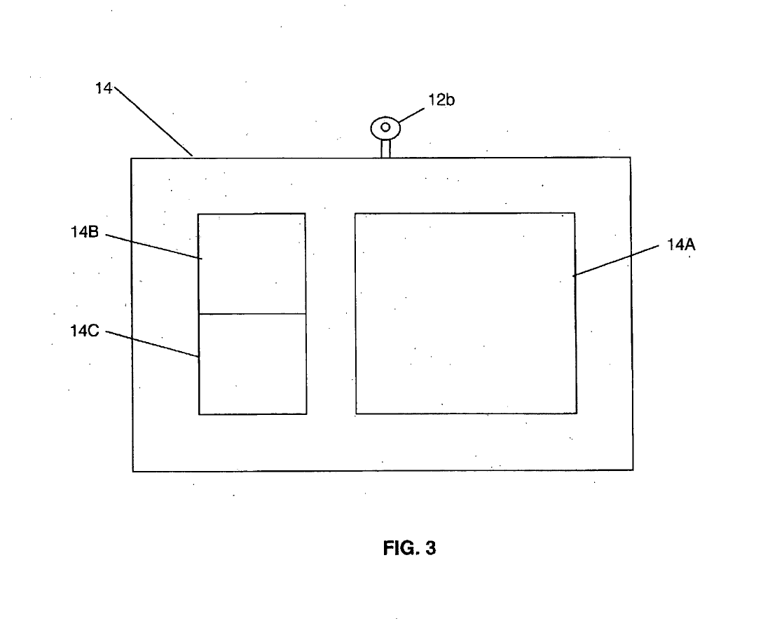

As shown in FIG. 3, in one embodiment of the present invention, a display device 14 may include multiple display elements 14a, 14b, and 14c respectively, each capable of displaying different content. In some embodiments, the display elements may represent digital screens, advertisements upon a billboard, mannequins in a collection, an artwork collection, or any other segments of a whole display. As an example in one embodiment of the present invention the display device 14 is segmented into three separate display elements 14a-14c. Thus display element 14a may be used for broadcast of a television show, whereas display element 14b may be used for the presentation of an advertisement and display element 14c for the broadcast of news items. It will be obvious to a skilled reader that a display 14 may incorporate display elements and present different forms of content depending on the type of display utilized.

The contents of the respective display elements 14a-14c of the display device 14 may be tailored to attributes associated with an audience in proximity of the display 14, being an audience area. Specifically, the attributes of the audience may allow for the targeted or customized presentation of the display. For example, in the case that the display is a digital display, the presentation of a particular advertisement, or specific news item may be triggered in accordance with the attributes of the audience in proximity to the display. A person skilled in the art will recognize the variety of display presentations that are possible depending upon the display type.

As shown in FIG. 3, in one embodiment of the invention, the display 14 may be a digital display, having display elements 14a-14c that are digital screens. A person skilled in the art will recognize that although three display elements are shown in FIG. 3 any number of display elements may be incorporated into any embodiments of the present invention. Moreover, a single display element, such as one individual display screen may be further divided into multiple areas, and each area may display different presentations or information.

Visitor Detection Module

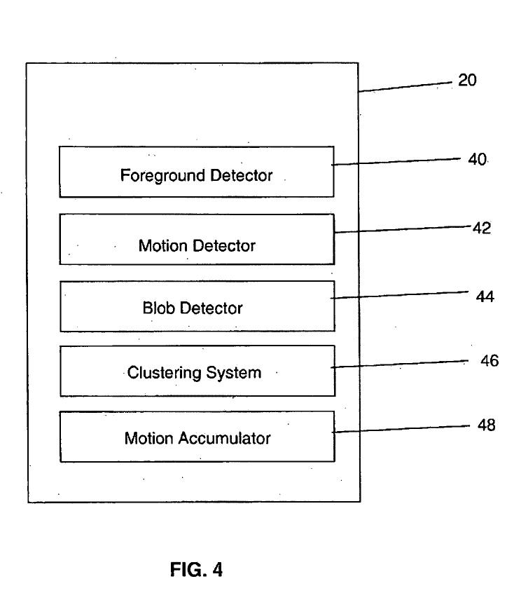

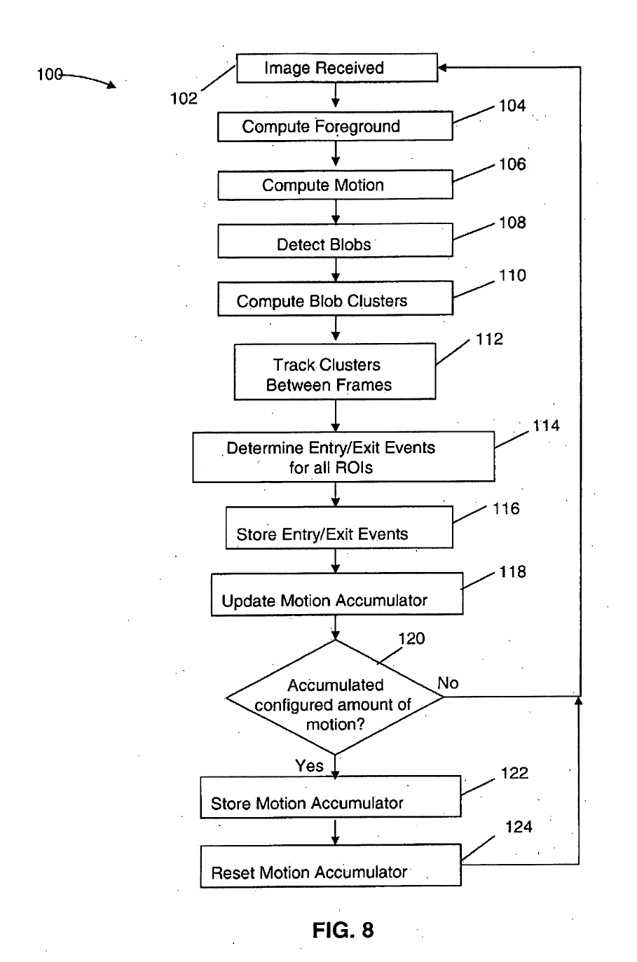

Embodiments of the present invention may generally include a visitor detection module 20, as shown in FIG. 4, for the purpose of accurately determining the number of people within the vicinity of a display. The people do not necessarily need to be viewing the display, but merely in its vicinity. In one embodiment, the system may include a colour camera 12a mounted overhead of the desired space in the vicinity of a display. Potential viewers can be determined within said desired space. Additionally, other cameras or sensors may be used in conjunction with the colour camera, such as infrared cameras, thermal cameras, 3D cameras, or other sensors. The camera may capture sequential images and at the fastest rate possible, for example, such as a rate of 15 Hz or greater. The image processing techniques, as shown in FIG. 8, may be used to detect the pixels of shapes that represent people or other objects of interest within the images. In another embodiment, pre-recorded data from the environment, such as images and sounds, may be used as inputs to the visitor detection module, either in conjunction with the camera input or as stand-alone input.

In one embodiment of the present invention, the first time the system is started, a training phase lasting approximately 30 seconds may capture a continuous stream of images from the camera. These images may be averaged together. The averaged image result may be utilized as a background image representing the camera view without people. Ideally, during the training phase no person should be present in the camera's field of view. However, the system is capable of configuration if there is minor activity of people moving through the audience area the camera focuses upon. Once the training phase is completed, the background image is stored in the system. In one embodiment of the present invention, if a camera, such as that represented as 12b in FIG. 1, is a colour camera and it is moved to a different location during the function of the system, the user may re-initiate the training phase manually. In another embodiment of the present invention, the training phase may be configured to automatically run at a regular frequency of time, for example, such as 24 hour intervals, or alternatively every time the system is restarted.

The training phase may be performed for all of the cameras utilized in an embodiment of the present invention.

Another aspect of an embodiment of the present invention is a configuration step. At this point a user may define one or more regions of interest (ROI) within an image captured by the camera view. A ROI may be defined by interactively connecting line segments and completing an enclosed shape. Each ROI is assigned a unique identifier and represents a region in which visitor metrics may be computed.

Furthermore, during the configuration step, a user may also set the size of an individual in the camera's view. This can be accomplished through the application of either an automated or manual configuration procedure. To undertake the manual approach, a user may define an elliptical region over an image of a person captured by the installed camera's view by interactively drawing the boundaries of said region. This may be achieved by way of a graphical use interface and a computer mouse. Although a skilled reader will understand that other methods of defining an elliptical region are also possible. The defined elliptical region can represent the area that any individual in the image may approximately occupy. Since the area an individual occupies may change based upon where they are standing with respect to the camera, the user may be required to define multiple ellipses, for example nine ellipses may be required. These multiple ellipses represent the area occupied by a single person if they move to stand in various locations of the camera view. For example, if the person stood at the top-left, top, top-right, right, bottom-right, bottom, bottom-left, left, and center of the image with respect to the placement of the overhead camera. The area occupied by an individual area may be approximated at any other location in the image by linearly interpolating between these calibration areas.

In one embodiment of the invention configuration may be automated. To achieve automated configuration at least two users must be present. One user may walk to the different regions, while the second user instructs the software to configure a particular region where the first user is positioned. Instructions may be given to the software in a variety of manners, for example by pressing a key on the keyboard. Although a person skilled in the art will be aware that many other methods of providing instructions to the computer may be utilized. The area of the first user in each of the regions may be extracted through a method of background: subtraction. In another embodiment of the present invention, a single user may configure the system using a hand-held computing device to interface with the configuration software. This user may walk from region-to-region, using the hand-held computing device to instruct the software to configure a particular region where the user is positioned

A further embodiment of the present invention causes two thresholds to be defined during the configuration. These thresholds may be used by the system and can be defined by a user. The first threshold t1 represents an image subtraction threshold, generally to be set between 0 and 255, where gray pixel intensity differences exceeding t1 are considered to be significant and those less than t1 are considered to be insignificant. This first threshold may be set on an empirical basis, in relation to the particular environment and camera type, where lower values increase the sensitivity of the system to image noise.

The second threshold t2 may define the maximum distance that an individual can move between frames, for example, as measured in pixels. This threshold may be used to detect individuals between frames captured by the camera. Larger values of t2 may allow for detection of fast movements, but such values may also increase detection of errors. Lower values may be desirable but they require higher capture and processing rates.

Additionally, an accumulation period, for example, one measured in seconds, may be set during the configuration. The accumulation period may represent the finest granularity at which motion data should be stored.

As shown in FIG. 8, one embodiment of the present invention includes a visitor detection method 100. The steps of the visitor detection method 100 may cause processing of each image 102 captured by the camera. 12a to proceed as follows:
Each new image from the camera may be first processed by subtracting the pixels in the background image 40 from the pixels in the new image 104. Pixels with an absolute difference above the pre-configured threshold t1 may be marked as foreground, and all others may be marked as background. This information can be stored in a foreground mask as a binary image consisting of black (background) and white (foreground) pixels.
Each new image may then be subtracted from the previous image 106, and pixels with an absolute difference above the pre-configured threshold t1 can be designated as motion boundaries 42, while all others may be designated as static or non-moving. The previous image may be a black image if the new image is a first image. The results of this step may be stored in a motion mask as a binary image, where motion areas are set to white and non-motion areas are set to black.
For the pixels in the foreground mask designated as foreground, connected regions (blobs) 108 may be determined 44.
For each blob, the number of individual people represented within its boundaries may be estimated by dividing the area of the blob by the known area that a single person may occupy, as was determined during the configuration.
The pixels inside of each blob may be assigned to a single person by a k-means clustering algorithm 110, where k is the rounded number of people in the blob 46. Each cluster therefore represents a single person, and the centroid of the cluster represents its position in the image. Blobs that cover an area less than a single person may be ignored.
Clusters may consequently be detected 112 between images. A correspondence between a cluster in the current image and a cluster in the previous image may be formed if the distance between the centroids of each cluster is minimal and below the pre-configured threshold distance t2. If no such correspondence can be made for a particular cluster in the current image, or if the new image is the first image, the particular cluster may be considered to be a new person and may be assigned a new unique visitor ID. If no such correspondence can be made for a particular cluster in the previous image, that cluster may be considered to be lost.
Each time a new camera image is processed, all of the detected clusters may be checked to see if they have crossed the boundary of any ROI 114. Any entry into a ROI results in an increase of the ROI's daily entry count. Similarly, any exit from a ROI results in an increase of the ROI's daily exit count. Each entry and exit event may be recorded 116 in the analysis database 28. Entry and exit event entries may include a time stamp indicating when the event occurred, as well as with the ROI label corresponding to the entry/exit event. In one embodiment a log entry may resemble the following basic format: YYYY/MM/DD, HH:MM:SS, event_type, visitor_id, roi_label (where event_type is either “entry” or “exit”). However, a person skilled in the art will recognize that log entries may include less or more information than the basic format.
A motion accumulator image 48 may be created matching the size of the motion image. For every pixel in the motion image that is non-black, the corresponding value in the motion accumulator image may be incremented 118, for example the increment can be set to occur by ones. This can occur each time the motion image is updated. After each period of accumulation 120, based upon the accumulation period value set during the configuration, the motion accumulator image may be stored 122 in the analysis database 28. At this point the motion accumulator image may be reset 124.

In various embodiments of the present invention, the steps of the visitor detection module may occur in various orders and are not restricted by the ordering presented above.

Viewer Detection Module

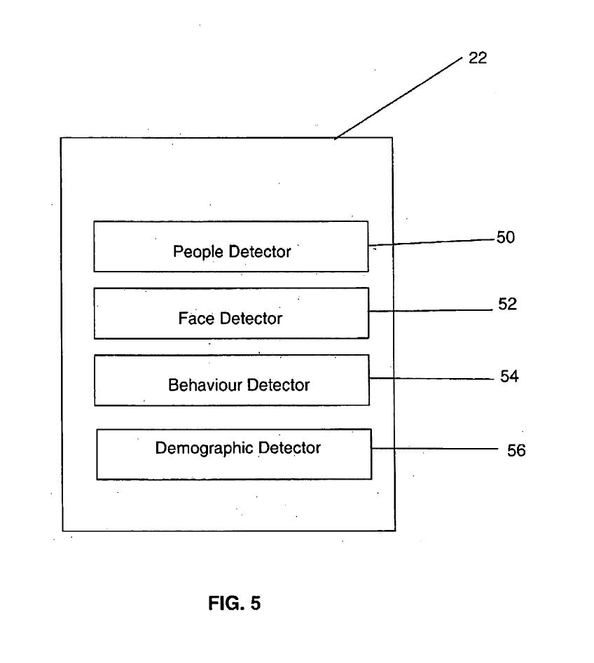

In one embodiment of the present invention, the viewer detection module 22, as shown in FIG. 5, may analyze images captured by the camera 12b to determine the various attributes associated with individuals positioned in front of the display. Other cameras or sensors may be used in conjunction with the colour camera, such as infrared cameras, thermal cameras, or 3D cameras, or other sensors.

In another embodiment of the invention, in order to establish a wide field of view with minimal image distortion, two cameras may be used. The two cameras may be positioned such that an overlap zone occurs between the field of view of both cameras. The amount of overlap can either be fixed at a percentage, for example 20%, or can be specified during a configuration step. One method of defining the overlap may be for a user to interactively highlight the overlap regions using a graphical user interface to generate an overlap mask for each camera. Although a skilled reader will understand that other methods of defining the overlap are also possible, including the use of more than two cameras, each having a view overlapping with that of at least one other camera.

In yet another embodiment of the present invention, a user may also specify a set of at least 4 corresponding points in each of the two camera images to establish the transformation between the two cameras. This may be undertaken through the application of the approach of Zhang, Z. (2000), IEEE Transactions on Pattern Analysis and Machine Intelligence, 22(11): 1330-1334, which describes a flexible technique for camera calibration. Once the overlap region and transformation have been established, correspondences for individuals in the overlapping region may be established. This may prevent the system from double-counting audience members when they appear in multiple camera views.

In one embodiment of the invention, sequential images may be captured from the camera at the fastest rate possible, for example 15 Hz or greater, and image processing techniques may be used to extract attributes from the images. The attribute results may be stored in the analysis database 28.

In yet another embodiment of the present invention, pre-recorded data from the environment, for example images or video, may be used as inputs to the viewer detection module.

It will be understood by a person skilled in the art that while the modules of the present invention are described with respect to the detection of attributes associated with individuals, they may also be used to detect various attributes associated with other objects detected in the images captured by the, system 10, such as automobile colours, logos on clothing, or food items being consumed.

An embodiment of the present invention encompassing the components associated with the viewer detection module 22 is shown as FIG. 5. The viewer detection module 22 may include a people detection module 50, a face detection module 52, a behaviour detection module 54, and a demographic detection module 56. The people detection module 50 may be used to detect heads and shoulders of individuals that may not be looking towards the display, including back views and side profile views. The people detection module thereby can provide a coarse estimate of overall visitors. The face detection module 52 can function in regards to an image recorded by a camera positioned to capture faces, such as camera 12b. As one image may capture multiple individuals who are part of the audience, the face detection module 52 may be used to analyze the image to detect the various individuals that are part of the image and which individuals are looking towards the display.

Once an individual has been detected in the image, and has been determined to be looking towards the display, attributes of the individual may then be determined by the behaviour detection module 54 and the demographics detection module 56. The behaviour detection module 54 may determine for each detected individual: the position of the individual with respect to the display; the direction of the gaze of the individual; and the time that the individual spends looking towards the display, which is referred to as the viewing time. The camera which may continuously capture images while the system is functioning, may operate at a fast speed, for example at 15 Hz or greater, and the images may be processed by the visitor detection module at fast rates close to camera capture rates, for example rates of 15 Hz or greater.

The demographic information that may be determined by the demographic detection module 56, includes several elements, such as the age, gender, and ethnicity of each individual that is a member of the audience and is captured in an image. A person skilled in the art will recognize that additional demographic information may also be determined by the demographic detection module.

The behaviour and demographic information associated with each individual are also referred to as “attributes”.

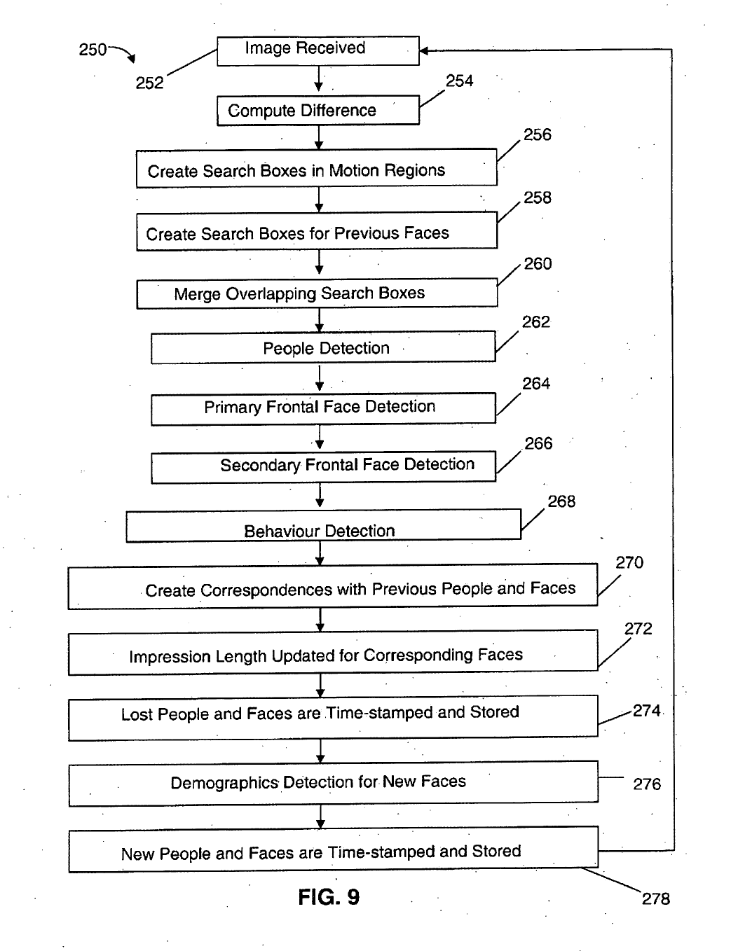

In one embodiment of the present invention, as shown in FIG. 9, a viewer detection method 250 may be applied. The viewer detection method may be used to detect the presence of one or more individuals viewing a display device 14. In another embodiment of the present invention, during an optional configuration step, a user has the option of defining a minimum and maximum face size that may be detected by the system. These minimum and maximum values may be specified either in pixels, metric units, or based on the desired minimum and maximum face detection distances.

In another embodiment of the present invention, the viewer detection method 250 may function in accordance with default values for minimum and maximum face size, derived from the analysis of specific scenarios. For example, the user may be asked for basic inputs including approximately how far from the screen the minimum and maximum distance will be to find a face. This minimum and maximum face size can optionally be configured automatically by storing the most common face sizes across a specified time range, such as a twenty-four hour period. A statistical analysis of the stored face sizes can then be used to extract the optimal minimum and maximum face size values to help minimize processing time. Minimum and maximum head sizes may also be computed by doubling the minimum and maximum face sizes respectively. This function and establishment of default values may be based on the assumption that the head/shoulder of a human occupy twice the area of the face.

In an embodiment of the invention, once maximum and minimum face sizes are determined, images captured by the camera may be processed 252 as follows:
A difference image result may be computed 254 by subtracting a new image from a previously captured image. If the new image is a first image, then the previously captured image may be a black image. The subtraction function can be achieved through the identification of pixels within the new and the previously captured images and the subtraction of pixels of the new image from those of the previously captured image. The absolute difference for each pixel may be compared against a threshold, so that only pixel differences above the pre-determined threshold value may be set to white, while all other pixels may be set to black.
A search box 256 may be centered around all pixels in the difference image result set to white. The size of each search box may be set to a multiple of the face size. For example, the search box size may be set to two times the maximum face size in the x and y dimensions.
Additional search boxes may be centered around frontal faces 258 detected in a previous image. These additional search boxes may be a size that is a multiple of the face size. For example, the additional search boxes may be set: to two times the dimension of the face in both the x and y directions.
Overlapping search boxes may be merged together 260.
A people detection algorithm 262 may be performed which looks for regions within each search box that resemble the head and shoulders of a human body. The search may be performed for all head sizes between the minimum and maximum head sizes. Each search box may be scanned from the top left to the bottom right, although other scan directions may also be applied.
All individuals detected by the people detection algorithm may be added to a current active people list. The current active people list may be stored in a temporary storage area in system memory. The list may be used to maintain the status of detected people across all images. Information stored in the current active people list may include information such as, a unique id, a start time, an end time, a position in the image, for example, expressed as x and y pixel coordinates. However, the current active people list entries may include other information, and thereby include either more or less information than suggested herein.
People detected in a previous image and recorded in the previous active people list may be corresponded with the people in the current active people list. Correspondence may be recognized by way of a search for a person with a maximum amount of overlapping data.
If a previous active people list record is found to correspond to a current active people list record, then the unique person ID associated with the current active person list record may be assigned to be the same as that of the corresponding previous active people list record.
If no current active person list record is found to correspond with a previous active person list record, the person represented by the previous person list record may be considered to be lost. An entry may be stored in the analysis database to denote the end of the detection of a person. The entry may resemble the following basic format: YYYY/MM/DD, HH:MM:SS, person_end, person_id. However, the analysis database entry may include other information, and thereby include either more or less information than suggested herein.
If no previous active person list record is found to correspond with a current active person list entry, the person represented by the current person list entry may be considered to be a new person. A new unique person ID may be assigned to the person and included in the current active person list record. A new person entry may also be made in the analysis database. The entry may resemble the following basic format: YYYY/MM/DD, HH:MM:SS, person_start, person_id. However, the analysis database entry may include other information, and thereby include either more or less information than suggested herein.
A primary frontal face detection algorithm 264 may be performed for all face sizes between the pre-configured minimum and maximum dimensions within each search box. Face detection may be accomplished by scanning each search box from the top-left to the bottom-right, although other scan directions may also be applied.
All frontal faces detected by the frontal face detection algorithm may be added to a current active face list. The current active face list may be stored in a temporary storage area in system memory. The list may be used to maintain the status of detected faces across all images. Information stored in the current face people list may include information such as, a unique id, a start time, an end time, a position in the image, for example, expressed as x and y pixel coordinates. However, the current active face list entries may include other information, and thereby include either more or less information than suggested herein.
For each face recorded in the current active face list, a secondary face detection algorithm 266 may be performed. Faces that fail the secondary detection process may be removed from the current active face list.
Behaviour data 268 may be determined for all faces in the current active face list, such as gaze direction, expressions, and emotions. Although, a person skilled in the art will recognize that other behaviour data may also be obtained. Behaviour data may be stored in the corresponding current active face list record.
Faces detected in a previous image and recorded in the previous active face list may be corresponded 270 with the faces in the current active face list. Correspondence may be recognized by way of a search for a face with a maximum amount of overlapping data. A similar procedure is applied to people in order to compute correspondences between people in the current active people list and the previous active people list.
If a corresponding previous active face list entry is located for a current active face list entry, the viewing time 272 for the current active face list entry may be set to the viewing time of the previous active face list entry plus the amount of time that has elapsed since the previous image was captured. Furthermore, the viewer IDs associated with both entries, the corresponding previous and current entries, may be the same.
If no current active face list record is found to correspond with a previous active face list record, the face from the previous active face list record may be considered to be lost 274. Behaviour information from the previous active face list record may be utilized to produce behaviour averages for each face. For example, behavioural data may be utilized to calculate an average viewing direction or an average expression. An entry may be stored in the analysis database to denote the end of the viewing time. The entry may resemble the following basic format: YYYY/MM/DD, HH:MM:SS, impression-end, viewer_id, demographic_data, behaviour_data. However, the analysis database entry may include other information, and thereby include either more or less information than suggested herein.
Any time a change is made in behaviour for a particular face, an event may be stored in the analysis database. For example, an entry may be made in the analysis database to denote the change in viewing direction of the viewer. The entry may resemble the following basic format: YYYY/MM/DD, HH:MM:SS, impression_update, viewer_id, demographic_data, behaviour_data. However, the analysis database entry may include other information, and thereby include either more or less information than suggested herein.
If no previous active face list record is found to correspond with a current active face list entry, the face from the current active face list entry may be considered to be a new viewer 276. A new unique viewer ID may be assigned to the face and the initial viewing time be set at zero. Demographics may also be determined at this time. A new viewing entry may also be made in the analysis database 278. The log entry may resemble the following basic format: YYYY/MM/DD, HH:MM:SS, impression_start, viewer_id, demographic_data, behaviour_data. However, the analysis database entry may include other information, and thereby include either more or less information than suggested herein.

In various embodiments of the present invention, the steps of the viewer detection module may occur in various orders and are not restricted by the ordering presented above.

In one embodiment of the present invention, head and shoulder detection may be used to detect visitors located in front of the display, who are not necessarily facing the display. The shape of the head and shoulders of humans is unique and facilitates a detection process applying statistical algorithms, such as the one described in Viola, P., Jones, M., (2004) “Robust Real-time Face Detection”, International Journal of Computer Vision, 2004 57(2):137-154. Other approaches based on background subtraction, contour detection and other workable methodologies may also be applied.

In some embodiments of the present invention, the results of the people detection process using the front facing camera 12b can be susceptible to significant occlusions. Therefore, the resulting count of individuals may not be as accurate as that of the visitor detection module, which uses an overhead camera 12a. However, the results of the people detection process may be useful to provide visitor-to-viewer statistics. Furthermore it may provide opportunities-to-see (OTS) estimates when used with the business intelligence tool in scenarios where an overhead detection system is not feasible.

In one embodiment of the present invention, frontal face detection may be used to detect viewers facing a display. This detection may be based on the assumption that viewers looking towards the display will also be front facing towards the camera, if the camera is placed directly above or below the display. It is a feature of the present invention that faces may be detected in an anonymous manner, meaning that no information applicable to identifying a specific person may ever be retrieved based on the detection process. In this manner, the present invention differs from face recognition algorithms applied in other methods and systems, which are able to identify unique attributes between two or more faces, to a level of granularity where the data collected can be used to personally identify an individual.

In another embodiment of the invention, search boxes may be utilized to improve face detection efficiency, causing detection to occur in real-time or near real-time, being at or close to the capture rate of the camera. Real-time performance may avoid the need to store images over long-periods of time for processing at a later time, and therefore may aid in ensuring that any potential for a violation of privacy laws is avoided. Additionally, real-time detection can be utilized to cause a display to present targeted media to an audience, whereby the media presented may be based on the aggregate attributes of an audience. Traditional approaches that scan each image fully cannot achieve this type of targeting, because they are inefficient and have difficulty scaling up to higher-resolution image streams.

Although, no long-term information is ever stored for any particular face, in one embodiment of the present invention short-term memory of statistical information may be maintained in the system memory for any detected face in order to account for individuals that may look at the display, look away for a few seconds, and then look back at the display. This statistical information may consist of a weight vector using the EigenFaces algorithm of Turk, M., Pentland, A., (1991), “Eigenfaces for Recognition”, Journal of Cognitive Neuroscience 3(1): 71-86. However, a person skilled in the art will recognize that other information, such as colour histograms, may also be used.

In one embodiment a two-pass approach to frontal face detection may be used in order to improve accuracy and reduce the number of false detections. Any frontal face detection algorithm can be used in this phase, although it may be preferable that the chosen algorithm be as fast as possible. The face detection algorithm applied may be one based on the Viola-Jones algorithm (2004), but other approaches, for example, such as an approach based on skin detection, or an approach based on head shape detection, may be used as well. The secondary face detection algorithm may be slower than the first face detection algorithm, and may consequently also be more precise, since it will be performed less frequently. A suitable secondary face detection algorithm may be based on the EigenFaces approach, although other algorithms may also be applied.

In one embodiment of the invention, behaviour detection may primarily include determining gaze direction, but other facial attributes can be detected as well, such as expressions or emotions. Once a rectangle around an individual's face has been determined using the two-pass face detector described earlier, the rectangular region in the image can be further processed to extract behaviour information. A statistical approach such as EigenFaces or the classification technique described by Shakhnarovich, G., et al., (2002) “A Unified Learning Framework for Real-Time Face Detection and Classification”, IEEE International Conference on Automatic Face and Gesture Recognition, pp. 14-21, may be applied. Both of these algorithms use a training set of sample faces for each of the desired classifications, which can be used to compute statistics or patterns during a one-time pre-processing phase. These statistics or patterns can then be used to classify new faces at run-time by processing regions, such as the rectangular face regions. However, other approaches to the extraction of behaviour information, besides those computing statistics or patterns during a one-time pre-processing stage, may also be applied.

In one embodiment of the invention a gaze direction detector may be utilized to allow for more precise estimates of frontal faces. Greater precision may be achieved through the categorization of each face as being directly front-facing, facing slightly left, or facing slight right with respect to the display. Expressions such as smiling, frowning, or crying may also be detected in order to estimate various emotions such as happiness, anger, or sadness. Behaviour data may be detected for each face in every image, and each type of behaviour may be averaged across the viewing time for that particular face.

In another embodiment of the present invention, demographics may be determined using statistical and pattern recognition algorithms similar to those used to extract behaviour, such as that of EigenFaces or alternative classification techniques, such as Shakhnarovich (2002). Of course, algorithms other than those related to statistical and pattern recognition may also be applied. The algorithms may require a pre-processing phase that involves the presentation of a set of training faces representing the various demographic categories of interest to establish statistical properties that can be used for subsequent classifications. The gaze direction detector may allow for more precise estimates of frontal faces by categorizing each face as being directly front-facing, facing slightly left, or facing slightly right with respect to the display.

In embodiments of the present invention, demographic detection may include many elements, such as age range (e.g. child, teen, adult, senior, etc.), gender (e.g. male, female), and ethnicity (e.g. Caucasian, East Asian, African, South Asian), height, weight, hair colour, hair style, wearing/not wearing glasses, as well as other elements. Demographic data may only be computed when a face is first detected and a new viewer ID is established for said fee. In the event that demographics cannot be determined accurately due to low image quality or large distances between the camera and a face, such attributes may be categorized as unknown for the current face.

Content Delivery Module

In one embodiment of the present invention, the content delivery module 24 may be used to determine the content or media to be displayed. For example, if the display is a digital display device, the content may be video feeds shown upon the respective digital display segments 14a-14c. If the display is artwork, the content will be the particular piece of art or collection of artwork that is displayed. The content delivery module 24 may operate in various modes, such as a mode whereby media provided to a display device 14 may be predetermined, or a mode whereby the media may be selected based on the attributes of the individuals that are either viewing the media presently or in the vicinity of the display device 14. Additionally, content can be targeted based on various inputs including temperature sensors, light sensors, noise sensors, and other inputs. A person skilled in the art will recognize that other modes are also possible.

Additionally, a skilled reader will recognize that content can be obtained from many sources. In particular digital content may be stored internally within the system, it may also be obtained from an external source and may be transferred to the system in the form of a video feed, electronic packets, streaming video, by DVD and any other external source capable of transferring digital content to the system.

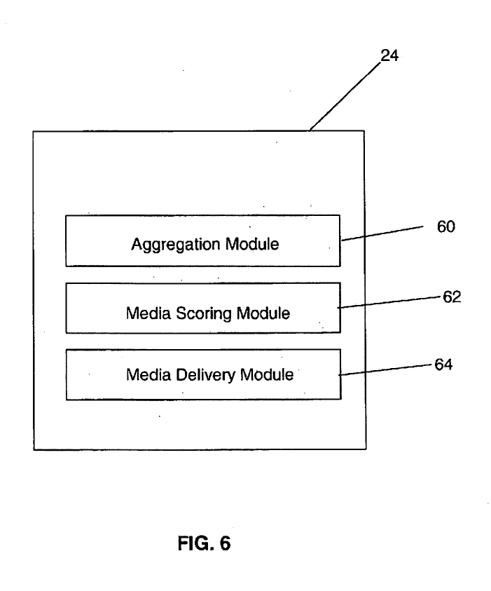

As shown in FIG. 6, one embodiment of the present invention includes a content delivery module 24 having several modules therein, such as an aggregation module 60, a media scoring module 62, and a media delivery module 64. The content delivery module 24 may be used to select media for display upon the display device 14. The content delivery module 24 may also continuously ensure that the display device 14 is provided with appropriate media, meaning media that has either been pre-selected, or may be selected in real-time or near real-time based on the attributes of an audience.

One mode of operation, referred to as a playlist mode may provide media for display by choosing media from a list, the order of which has been predetermined. The various media provided to the display devices may be part of what are referred to as playlists. Playlists may include one or more instances of variant media, such as advertisements, video clips, painted canvasses, or other visual presentations or information for display. Each media may be associated with a unique numerical identifier, and descriptive identifiers. Playlists may be generated through many processes, such as: manual compilation whereby a user specifies the order of a playlist; ordering based on a determination of compiled demographic information; or categorization by day segment, such that different content plays at different times of the day. Other means of playlist generation may also be applied.

In one embodiment of the present invention, a media identifier may reference specific media and may also be used to index media. A media identifier may be a 32-bit numerical key. However, in alternative embodiments identifiers of alternative sizes and forms may be used, such as string identifiers that provide a description of the underlying media. Each media may have several descriptive tags, for example meta tags that are associated with the media content. Each meta tag will have a relative importance weighting—in one embodiment of the invention the weighting for all meta tags for each unique media must add up to 1.0. As individual media is shown on the display, timestamped start and stop events may be stored in the analysis database 28. A business intelligence tool may utilize this information to establish correlations between displayed media and the audience size and viewer attributes while the media was shown.

In another embodiment of the present invention the content delivery module 24 may operate in a targeted media delivery mode, where the display 14 is used to present media or content targeted to a specific audience determined to have particular attributes, the content delivery module 24 operates in a targeted media delivery mode. The targeted delivery mode may collect audience data, or other time-specific information, such as temperature, lighting conditions, noise, and other inputs, and customize the media or content displayed based on such data. As has been described, each instance of media that is stored in the media database 30 may have media identifiers associated with it that may be used to determine which media instance should be displayed upon the respective display device based on collected data, such as audience attributes.

Media attributes may also be associated with media or content, including: desired length of viewing; demographics; target number of impressions; and scheduling data. For example, where it is determined that the individuals are viewing a display device for an average length of time in minutes, where possible, media that takes that information into account may be displayed. For example, if the display is a digital device and the content is a sports broadcast, the length of a clip shown may be chosen in accordance with the viewing length information. Further, where the average gender profile of the audience is determined, this demographic information may be used to target media to the audience. Demographic information may be collected through the analysis of an audience, as produced by the viewer detection module.

In one embodiment of the present invention, the mode of operation, such as playlist mode or targeted media mode, may be specified at more than one possible point. For example, the mode may be chosen when at time the system 10 is configured, or it may be switched during operation of a display by way of a control activated by an authorized user, or the mode may be switched automatically based on the time of day, or day of week. A skilled reader will recognize that additional choices for switching the mode of operation may be utilized.

Playlist Mode

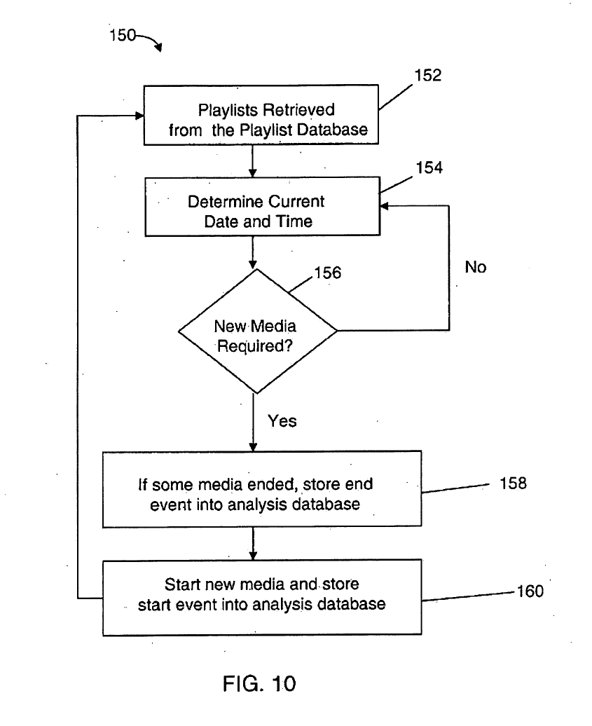

An embodiment of the present invention including the content delivery method 150 in playlist mode is shown at FIG. 10. The content delivery method 150 may be used to deliver media or content to one or more specific display devices 14. The content delivery method 150 may undertake several steps. Step 152 allows for playlists to be retrieved from a playlist database. At step 154, the current date and time may be determined. The date and time may be relevant as the playlist delivery method has associated media that should be displayed at specific events or times. For example, certain media may be displayed in a food court at lunchtime, or an advertisement may be displayed on a screen of a specific restaurant in a food court. Step 156, allows for a determination as to whether a new media item is required based on several factors: the playlist schedule; the current date/time; or if the previous media has ended. If new media is required in accordance with the playlist, step 158 may record a media end event in the analysis database 28 at the end of media display occurring in step 156.

Step 160 may indicate or start the next media to be displayed. The business intelligence tool can analyze data collected during the playlist mode to evaluate the effectiveness of certain media by correlating the media start/end events with the audience and impression events stored by the visitor detection module and viewer detection module. The steps of the method are cyclical and will continuously recycle as long as the playlist mode is chosen and the system is functioning.

Targeted Media Mode

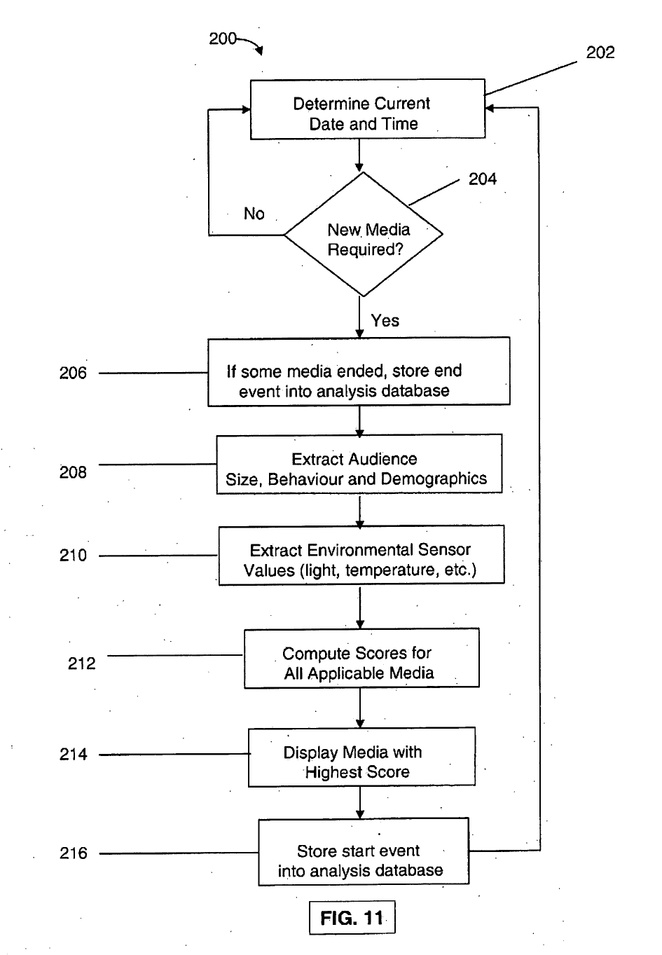

An embodiment of the present invention including a targeted media delivery method 200 is shown at FIG. 11. The targeted delivery method 200 indicates or causes targeted media to be delivered to a respective display device 14. The media to be displayed upon the display device may be selected by querying the viewer detection module and visitor detection module for real-time, or near real-time, audience attributes, and choosing media identified as corresponding to these attributes stored in the media database. Step 202 allows for an identification of the current date and time. Step 204 determines if new media is required to be displayed on the display device 14. New media may be required if there is no existing media displayed, or if the existing media has expired. When media concludes a media end event may be stored in the analysis database. Optionally, for media that has ended, accumulated audience information during the playback of the ended media may be sorted into the media database in order to adjust future targeting parameters. For example, if a particular media identifier wanted to display an advertisement to only ten females, and this was achieved, then this information can be fed back to the media database in order to update the media identifier and alter future targeting parameters.

If new media is deemed to be required, step 208 may involve an extraction of aggregate audience size, behaviour and demographic information through querying of the visitor and viewer detection modules. The query can be made either as a local or remote procedure call from the content delivery module. Optional environmental sensor values, at step 210, may also be extracted at this point, for example pertaining to light, temperature, noise, etc. The resulting data, for example audience data, may consist of instantaneous audience information or aggregate audience information across a time range specified in the procedure call, for example ten seconds. These attributes may be then compared against the desired audience and environmental attributes associated with each media to compute a score for the media at step 212. The media having the highest score may be indicated or displayed 214, and a media start event may be stored in the analysis database 216. A skilled reader will recognize that the score may be computed through a variety of methodologies.

In one embodiment of the present invention, attributes associated with each media, may include several elements, such as: the number of desired viewings of the display device over a certain time frame; a desired gender that the media is targeted towards; or other demographic or behaviour data. The desired gender in this exemplary embodiment may be 0 for males and 1 for females, and the average gender may be set to 0 if the majority of the audience within a certain predetermined time frame, such as, for example, thirty seconds, were men, or 1 if the majority of the audience members in the predetermined time frame were women. A media score may be calculated for each media item stored in the respective media database, and the media with the highest score may be chosen for display. The equation used to determine the media score may change based on the desired attributes associated with the media that should be displayed.

Meta tags may also be taken into consideration when determining what media to display to a given audience. For example, if time of day is more important than gender for some particular media, the system may take this into consideration using the weight parameters.

Other factors may also be taken into account when determining which media is to be displayed, such as the last time the particular media was displayed. As discussed above, in one embodiment of the invention, camera 12b may continuously capture images. Method 200 may ensure that the audience size, behaviour and demographic information are repeatedly extracted from the visitor and viewer detection modules. This continuous determination can allow for the continuous display of what is determined to be the most appropriate media, taking into account the attributes of the audience.

If new media is not required, in step 212 a similar algorithm is applied to that of step 206 to determine the media from the media database that is most suitable for display based on the aggregate audience size, behaviour and demographic information and any environmental sensor information. At the earliest moment when new media is required the best matched media may be indicated or displayed 214.

For media that has been displayed, step 216 may store a media start event in the analysis database so that audience attributes can be associated with the displayed media for processing by the business intelligence tool. Method 200 then repeats the process from step 202.

In situations where no audience members are present in front of the display, the system can either display a blank screen, a default image, or random media selection. This display choice can be specified during a configuration step by a user.

Business Intelligence Tool

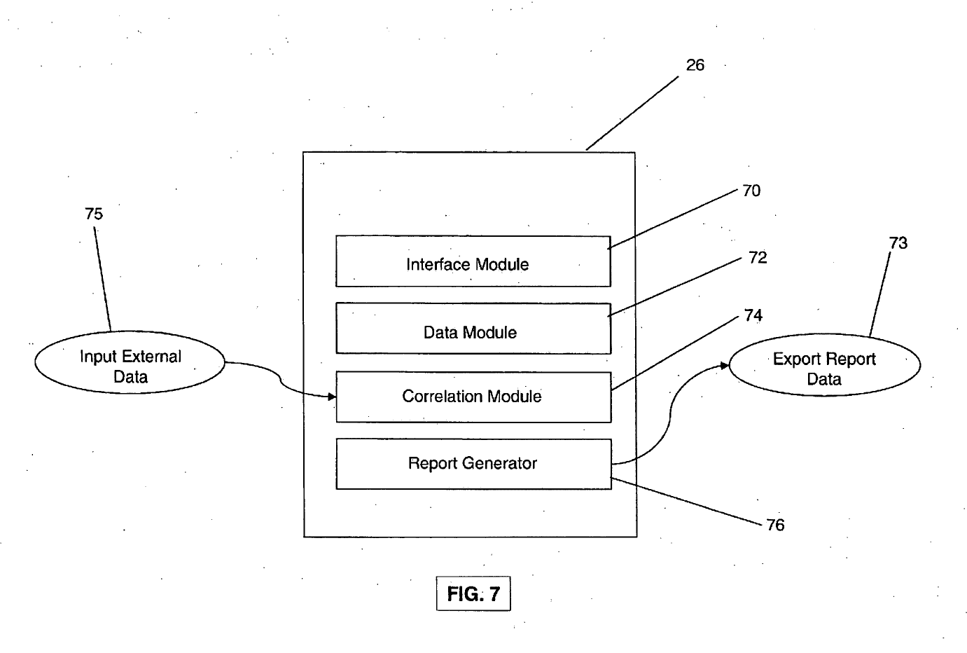

An embodiment of the present invention includes a business intelligence tool 26 and may use this tool to generate reports detailing the attributes of audiences. FIG. 7 shows an embodiment of the invention including business intelligence tool components: an interface module 70, a data module 72, a data correlation module 74, and a report generation module 76.

The interface module 70 may communicate with the audience analysis suite 16. More specifically, the interface module 70 may allow for communication where information pertaining to the display of media and attribute measurements associated with each display are provided.

In one embodiment of the present invention, the interface module 70 may provide for remote access to reports associated with the display of the media upon display devices. For example, web-based access may be provided, whereby users may access the respective reports via the World Wide Web. As will be obvious to a skilled reader, other forms of remote access may also be applied.

In one embodiment of the present invention, the data module 72 may compute averages for use in a report. The data module 72 may also specify other totals associated with the specific individuals in an audience. The data correlation module 74 may receive external data 75 from other sources, such as point-of-sale data, and use this to perform correlations between the external data and the data in any databases employed in the present invention. External data may be input to the system through the interface module 70.

The report generation module 76 may be based on the output of the data module and any optional correlations provided by the correlation module. Reports generally provide visual representations of requested information, and include many formats, such as graphs; text or tabular formats. Reports may also be exported 73 into data files, such as comma-separated values (CSV), or electronic documents, for example such as, PDF files, or Word files, that can be viewed at any time in the future using standard document viewers without requiring access to the business intelligence tool.

In one embodiment of the present invention, users may request reports based on all available data, which may include data, such as, any combination of display device segments, type of media, and any audience attributes. Other additional options may also be available in other embodiments. Based on the report requests, data from relevant databases may be extracted and presented to the user. As will be obvious to a skilled reader, a variety of databases and data sources may be applied in the present invention to produce robust reports.

In embodiments of the present invention various reports may be generated to produce a range of information, including reports reflecting the effectiveness of particular media or content. For example, embodiments of the invention may include any or all of the following functions:

Visitor Counts

Using the entry/exit data, the business intelligence tool may query the analysis database to generate reports regarding the number of people in any ROI for any desired time frame. A resulting report may be used to provide an assessment of the number of people in the vicinity of the display. Visitor counts may also be extracted from the analysis database based on individual media identifiers to determine the potential audience size for a particular media.

Dwell Time

The amount of time between the entry and exit of a cluster from a ROI may represent a dwell time. The business intelligence tool may query the entry/exit events in the analysis database to evaluate the average dwell time across any desired time range for a particular ROI. Additionally, dwell times across a number of ROIs may be combined to estimate service times, such as in a fast food outlet. For example, if it is the goal of a user to determine the average time it takes to travel from various locations, for example, such as ROIa that represents a lineup to ROIb that represents an order/payment counter, and then from ROIb to ROIc that represents an item pick-up counter, this can be computed using the entry/exit events in the analysis database.

Queue Length

If a ROI is defined to represent a queue, the business intelligence tool may report on the number of people within the ROI by extracting the entry/exit events from the analysis database for any desired time range. Queues can be defined by interactively specifying the ROI around a real-world queue using the image capture by the overhead-mounted camera 12a as a guide.

Traffic Heat Map

A motion accumulator image may be used to generate a traffic/heat map showing the relative frequency of activity at every pixel in an image. The business intelligence tool may generate the colour heat map image from the motion accumulator image as follows:
Compute the global minimum and maximum values in the motion accumulator image, and compute the range as maximum-minimum value.
Set pixels in the motion accumulator image that are 0 to black in the colour image.
Set pixels in the motion accumulator image that are between the minimum value and less than minimum+0.25 range to an interpolated gradient colour in the colour image between blue and cyan.
Set pixels in the motion accumulator image that are between the minimum+0.25 range and the minimum+0.50 range to an interpolated gradient colour between cyan and green.
Set pixels in the motion accumulator image that are between minimum+0.50 range and minimum+0.75 range to an interpolated gradient colour between green and yellow.
Set pixels in the motion accumulator image that are between minimum+0.75 range and minimum+1.0 range to an interpolated gradient colour between yellow and red.

The result may produce a traffic/heat map that shows infrequently visited parts of the scene as “cooler” colours, for example, such as blue or other cooler colours, while more frequently visited parts of the scene are shown as “warmer” colours, for example, such as red or other warmer colours. The business intelligence tool may generate and display a traffic/heat map by analyzing the motion accumulator images for any desired time range, whereby granularity may be defined by the maximum accumulation period of each stored motion accumulator image.

Viewing by Display

The viewing events stored in the analysis database may be aggregated for any desired time range using the business intelligence tool. This may be accomplished by parsing the impression events in the database and generating average viewer counts, viewing times, behaviours, and demographics for any desired time range. Therefore, for any given display, the total number of views may be determined for any time range. The impression events can also be used to determine the average viewing time for any particular display and time range. Additionally, total impressions and average viewing time may be compared across two or more displays for comparative analyses. In all cases, reports may be generated that segment out behaviour and demographic information.

Viewing by Media Identifier

The business intelligence tool may generate reports showing the number of views or average viewing time that a particular media received during any desired time range. This may be accomplished using the associations between media identifiers and audience attributes. Demographic information may also be segmented out for the generated reports.

Visitor-to-Viewer Conversion Rates

The combination of the visitor detection module based on images from an overhead camera and the viewer detection module based on images from a front-facing camera, as applied in some embodiments of the present invention, can allow the business intelligence tool to report visitor-to-viewer conversion rates for any desired time range. The reports may also be segmented based on demographics. In embodiments of the present invention which do not use the overhead detection module, the opportunities-to-see (OTS) features of the front-facing camera image directed viewer detection module can provide an estimate of the visitor counts.

Viewing by Time-of-Day or Day-of-Week

The business intelligence tool may aggregate viewing data, for example the total views and/or average viewing time, by time-of-day or day-of-week. Comparative analyses may also be performed to determine trends relating to a specific time-of-day or day-of-week during a set period of time.

A person skilled in the art will recognize that the aforementioned examples of its functions do not represent all of the possible functions of the business intelligence tool, but are merely presented as representative of its capabilities.

General Use Instances

For the purpose of further describing the present invention, examples of general use instances, such as those that apply to high-traffic environments, including for example, retailers, shopping malls, and airports, or that apply to captive audience environments, including for example, restaurants, medical centres, and waiting rooms are provided. Other high-traffic and captive audience environments may also be applied as general use instances. A person skilled in the art will recognize that these general use instance examples do not limit the scope of the present invention, but provide further examples of embodiments of the invention.

In an embodiment of the present invention, for general use instance a front facing camera may be embedded into or placed upon a display. An additional overhead camera may be positioned near the display, having a view over an audience area as determined by the user.

In another embodiment of the present invention, for general use instances, internet protocol (IP) network cameras may be connected to an on-site computer server located nearby, such as in a backroom. A PoE (Power over Ethernet) switch may be utilized to provide both power and a data connection to the network cameras concurrently. The server may process the camera feeds through the audience analysis suite applications, to extract audience measurement data and to store the data in the analysis database. The database, in the form of a log file, may be uploaded through an Internet or Intranet connection to a web-based business intelligence tool in accordance with a customizable schedule, such as nightly.

In yet another embodiment of the present invention, for general use instances, the content delivery subsystem may present content on the displays that is deemed appropriate based on user requirements. Such content may either be based on a playlist, or will be shown using a targeted media delivery method. Playlist and targeted content media data may be provided by the user and populated into the playlist and media databases. In one embodiment of the invention, the content delivery subsystem may be a third party system that interfaces with the audience analysis suite by means of an Application Programming Interface (API). Regardless of whether content targeting is a required feature, according to a user, audience measurement data may be aggregated to provide media effectiveness information.

Users may view audience measurement information by logging into the business intelligence tool through the Internet or Intranet. The web-based access tool can allow users to view reports that showcase the audience measurement data in various formats, such as in graphical and tabular formats, or any other formats.

Applications of embodiments of the present invention may serve different purposes in different environments where the invention is applied. The following information identifies some of those purposes. A skilled reader will recognize that additional purposes and benefits may be achieved by other embodiments and locations of the invention than those indicated in the following examples and therefore these examples do not limit the scope of the invention.

Queues:

In locations such as fast-food restaurants, grocery stores, and banks, where people form queues while waiting to complete their transactions, an overhead camera of the present invention may serve the dual purpose of analyzing both the potential audience size of a display, as well as the speed and efficiency of the movement of the queue of people. Additionally, the formation of queues is synonymous with the formation of captive audiences. In these environments, embedding a camera into displays may allow for targeted content to be shown to either help alleviate the perceived wait time of customers, or to help promote products and services based on the audience member profiles.

Kiosks:

In certain retail environments, the effectiveness of kiosks to engage audience attention may require monitoring. In a kiosk location one embodiment of the invention may use a digital USB camera embedded in a kiosk, which is plugged directly into a computer system housed within the kiosk running the audience analysis suite applications. The camera may be positioned and operable to capture one or more images permitting detection of movement of the targets in the area; and one or more images permitting establishment of attributes for the targets.

In another embodiment, an analog camera may be plugged into USB digitizers, which in turn plug into the computer system running the audience analysis suite applications. The computer system housed within the kiosk may process all of the camera images, and may upload the aggregated data at a regular interval, such as daily, to a web-based analysis database. A user may be able to review the audience measurement data by logging into the web-based business intelligence tool.

Shopping Malls/Airports/Large Stores

In a shopping mall or airport setting, where there are many displays dispersed throughout a large area, network cameras may be installed onto monitored displays. These network cameras may all connect to a series of on-site computers, for example computers located in a back room. One group of computers may be responsible for controlling the content delivery modules, and a separate group of computers may have the full responsibility of analyzing all the camera data. This can allow for the distribution of the computing processing load over a number of computers, which may allow the system to maintain high performance levels. In one embodiment of the present invention, the content delivery modules and audience analysis suite modules may operate on the same computer, for example a high performance computer, although other computers may also be utilized. The analyzed data may be uploaded to a web-based analysis database, thereby allowing a user to access the audience measurement data by means of a web-based business intelligence tool.

Viewer/Visitor Detection Focus

In certain environments, or to meet user requirements, an embodiment of the invention may be applied whereby only viewer audience data or visitor audience data is accessible. In such an embodiment, configurations such as the following may be applied: a front-facing camera may be embedded into displays, without a corresponding overhead camera. The visitor detection module may be disabled in this embodiment, while the balance of the system remains functional; or an overhead camera may be embedded over a ROI, without a corresponding front-facing camera being setup. The viewer detection module may be disabled in this embodiment, while the balance of the system remains functional. A person skilled in the art will recognize that other embodiments of the invention may be applied to produce similar results, whereby elements of the invention are made the focus of the invention, while others may be deemed unnecessary.

Utilizing Existing Cameras

In environments where an existing camera infrastructure is in place, such as a system of security cameras in a museum, the existing cameras may be utilized as inputs to the audience analysis suite if the image quality and camera angles are sufficient for the function of the present invention.

It will be appreciated by those skilled in the art that other variations of the embodiments described herein may also be practiced without departing from the scope of the invention. Other modifications are therefore possible. For example, any method and system steps presented may occur in an order other than that described herein. Moreover, a variety of displays, media and content may be applied.

What is claimed is:

1. An audience measurement and targeted media system comprising:
(a) a display for the presentation of content or media;
(b) one or more cameras positioned and operable to capture images of targets in an area in the proximity of the display; and
(c) an audience analysis utility that analyzes the images or portions thereof captured by the one or more cameras by processing the images or image portions so as to establish correlations between two or more images or image portions, so as to detect audience movement in the area and establish one or more audience attributes.

2. An audience measurement and targeted media system of claim 1 wherein the one or more cameras are positioned and operable to capture:
(a) one or more images permitting detection of movement of the targets in the area; and
(b) one or more images permitting establishment of attributes for the targets.

3. An audience measurement and targeted media system of claim 2 wherein the attributes include interaction between the targets and the display.

4. An audience measurement and targeted media system of claim 1 wherein at least one of said one or more cameras is positioned overhead of the area in proximity of the display.

5. An audience measurement and targeted media system of claim 1 wherein at least one of said one or more cameras is positioned facing outward from the display.

6. An audience measurement and targeted media system of claim 1 wherein the display encompasses display segments whereby the display may present one or more media simultaneously.

7. An audience measurement and targeted media system of claim 1 wherein the audience analysis utility has the following capabilities:
(i) deriving information from the images of said one or more cameras;
(ii) establishing attributes of individuals viewing the content or media of the display using the derived information;
(iii) controlling the display; and
(iv) storing data in one or more of storage mediums.

8. An audience measurement and targeted media system of claim 7 wherein attributes of individuals include behavioural and demographic attributes.

9. An audience measurement and targeted media system of claim 7 wherein a visitor detection utility derives information from the images of the one or more cameras.

10. An audience measurement and targeted media system of claim 7 wherein a viewer detection utility is applied to establish attributes of individuals.

11. An audience measurement and targeted media system of claim 7 wherein a content delivery utility is applied to control the display.

12. An audience measurement and targeted media system of claim 7 wherein a business intelligence tool generates reports based upon data stored in the one or more storage mediums.

13. An audience measurement and targeted media system of claim 1 wherein the audience analysis utility measures the effectiveness of the display device.

14. An audience measurement and targeted media system of claim 7 wherein the one or more storage mediums is a database.

15. An audience measurement and targeted media system of claim 1 wherein the audience analysis utility anonymously detects audience data.

16. An audience measurement and targeted media system of claim 1 wherein the audience analysis utility function in real-time or near real-time.

17. An audience measurement and targeted media system of claim 1 wherein the audience analysis utility detects the behavioural and demographic attributes of individuals appearing in images captured by the one or more cameras, as well as the movement of individuals therein, and the attributes of individuals are processed to represent audience attributes when the attributes of individuals within an audience are averaged against those of the other members of an audience and audience attributes are understood to represent an audience reaction to the media or content of the display.

18. A method of targeting media based on an audience measurement comprising the steps of:
(a) capturing images by way of one or more cameras of an audience within an audience area in proximity to a display;
(b) processing the images to identify individuals within the audience;
(c) analyzing the individuals to establish attributes;
(d) corresponding the established attributes to a media presented on the display at the time of the capture of the image; and
(e) tailoring media presented on a display to the attributes of an audience in the audience area.

19. A method of targeting media based on an audience measurement of claim 18 further including the step of identifying behavioural and demographic attributes as attributes of individuals.

20. A method of targeting media based on an audience measurement of claim 18 further including the step of storing data collected in one or more storage mediums.

21. A method of targeting media based on an audience measurement of claim 18 further comprising the steps of:
(a) applying a visitor detection utility to identify individuals;
(b) applying a viewer detection utility to establish attributes;
(c) applying a content delivery utility to correspond media on the display to established attributes of an audience; and
(d) applying a business intelligence tool to report the correspondence between media and the attributes of an audience.

22. A method of targeting media based on an audience measurement of claim 21 wherein applying the visitor detection utility comprises the further steps of:
(a) configuring the system including:
(i) defining regions of interest within an image;
(ii) defining a first threshold representing an image subtraction and a second threshold representing the maximum distance that a cluster can move between two images;
(iii) setting an accumulation period.
(b) creating a background image from multiple sequential images of the one or more cameras to represent the view of the camera without an audience therein during a training phase;
(c) processing images to identify individuals within an audience shown in the image.

23. A method of targeting media based on an audience measurement of claim 22 further including the step of defining a first and second thresholds utilizing pixel measurements.

24. A method of targeting media based on an audience measurement of claim 18 further including the step of storing data collected during each step in one or more storage mediums.

25. A method of targeting media based on an audience measurement of claim 21 the step of applying the viewer detection utility comprises the further steps of:
(a) establishing corresponding points in images of one or more cameras to identify the transformation between the cameras;
(b) establishing attributes of individuals through identifying faces of individuals;
(c) storing data collected during each step in one or more storage mediums.

26. A method of targeting media based on an audience measurement of claim 25 wherein establishing attributes of individuals may include demographic attributes and behaviour attributes.

27. A method of targeting media based on an audience measurement of claim 21 the applying the content delivery utility comprises the further steps of:
(a) aggregating audience attributes corresponding to media to create media attributes including creating and storing media meta tags;
(b) scoring media so that it is ordered in accordance with desired viewing levels relating audience and media attributes; and
(c) delivering media to a display for presentation thereon in either a playlist mode or a targeted media mode.

28. A method of targeting media based on an audience measurement of claim 21 the applying the business intelligence utility includes the further step of generating reports detailing the attributes of audiences in relation to media attributes.

29. A method of targeting media based on an audience measurement of claim 21 further including the step of presenting media on a display tailored to the attributes of an audience in the audience area in real-time or near real-time.

30. An audience measurement and targeted media system comprising:
(a) a display for the presentation of content or media;
(b) two or more cameras for capturing images of an audience area in the proximity of the display including;
(i) a first camera positioned overhead of the audience area;
(ii) a second camera positioned facing outward from the display.
(c) a computer having data processor capabilities including;
(i) a processor for deriving information from the images of said one or more cameras;
(ii) a processor for establishing attributes of individuals viewing the content or media of the display using the derived information; and
(iii) a processor for controlling, the display.

31. An audience measurement and targeted media system of claim 30 wherein attributes of individuals include behavioural and demographic attributes.

32. An audience measurement and targeted media system of claim 30 wherein one or more storage mediums are utilized to for the storage of data, including audience attributes.

33. An audience measurement and targeted media system of claim 30 wherein the display encompasses display segments whereby the display may present one or more media simultaneously.

34. An audience measurement and targeted media system of claim 30 wherein a visitor detection utility is applied to process images of the one or more cameras.

35. An audience measurement and targeted media system of claim 30 wherein a viewer detection utility is applied to ascertain responses of individuals to the display.

36. An audience measurement and targeted media system of claim 30 wherein a content delivery utility is applied to control the display.

37. An audience measurement and targeted media system of claims 30 wherein a business intelligence tool generates reports based upon data stored in one or more storage mediums.

38. A method of targeting media based on an audience measurement comprising the steps of:
(a) positioning in proximity to a display a first camera overhead of an audience area;
(b) positioning a second camera forward facing outwardly from the display to capture images of an audience area;
(c) capturing images by way the first and second cameras;
(d) processing the images to identify individuals within the audience;
(e) analyzing the individuals to establish audience attributes;
(f) corresponding the established audience attributes to media presented on the display at the time of the capture of the image; and
(g) tailoring media presented on a display to the attributes of an audience in the audience area in real-time.
